(19) United States
(12) Patent Application Publication
(10) Pub. No.: US 2009/0117282 A1
(43) Pub. Date: May 7, 2009

(54) DIFFUSION ALUMINIDE COATING PROCESS

(76) Inventors: Hideyuki ARIKAWA, Mito (JP); Akira Mebata, Kitaibaraki (JP); Yoshitaka Kojima, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/937,674

(22) Filed: Nov. 9, 2007

(30) Foreign Application Priority Data
Nov. 30, 2006 (JP) 2006-322752

(51) Int. Cl. B05D 3/02

(52) U.S. Cl. 427/383.7

(57) ABSTRACT

A method of applying a diffusion aluminide coating partially to a selective region more simply and conveniently, the method including a step of forming a metal aluminum film onto a selective region of the heat-resistant alloy substrate to be treated; and a step of applying a heat treatment to the heat-resistant alloy substrate on the selective region of which the metal aluminum film is formed and diffusing and penetrating aluminum in the metal aluminum film into the heat-resistant alloy substrate.

### BACKGROUND OF THE INVENTION

1. Field of the Invention

The present invention relates to a diffusion aluminide coating process to a selective region of a hot section part of a gas turbine.

2. Description of the Related Art

For hot section parts of the gas turbine (blade, nozzle, combustor, etc.) exposed to a high-temperature combustion gas, various kinds of heat resistant alloys excellent in heat resistance such as Ni-base and Co-base alloys are used as materials.

Further, onto the surface of those hot section parts, a diffusion aluminide coating is occasionally applied with an aim of providing thereto oxidation resistance and corrosion resistance at a high temperature.

In the case of a blade for the gas turbine, it is desirable to partially apply a diffusion aluminide coating to a selective region at the blade tip that is heated to a high temperature despite relatively low thermal stress and suffers oxidation damage.

On the other hand, in the case of a nozzle of the gas turbine, due to its wider allowable range for fatigue cracking compared with that of the blade, a diffusion aluminide coating can be applied over its entire surface more easily than in the case of an MCrAlX alloys overlay coating or a thermal barrier coatings (TBC). Also, the diffusion aluminide coating is often used due to its excellence in oxidation resistance and corrosion resistance.

However, even in the nozzle applied with the diffusion aluminide coating, degradation or damage occurs in the parts applied with the diffusion aluminide coating after use for a certain period, necessitating repairs to the damage. In most cases, since the degradation or damage that requires the repairs occurs in a restricted area of the nozzle, it is desirable to partially apply the diffusion aluminide coating to a selective region.

As a method of partially applying a diffusion aluminide coating to a selective region, methods as described in JP-A-2001-115250 (U.S. Pat. No. 6,485,780), JP-A-2002-194561 (U.S. Pat. No. 6,497,920), JP-A-2002-266064 (U.S. Pat. No. 6,533,875), and JP-A-2003-041360 (U.S. Pat. No. 6,560,870) have been proposed.

JP-A-2001-115250 (U.S. Pat. No. 6,485,780) discloses a so-called slurry method. The slurry method is a method of coating, drying and depositing slurry containing aluminum on the surface of a part and then applying a heat treatment to form a diffusion aluminide coating.

Further, JP-A-2002-194561 (U.S. Pat. No. 6,497,920) and JP-A-2002-266064 (U.S. Pat. No. 6,533,875) disclose similar methods of applying diffusion aluminide coating mainly on the surface of an internal cooling path of a blade.

JP-A-2003-041360 (U.S. Pat. No. 6,560,870) discloses, as a method of partially applying a diffusion aluminide coating, a method of preparing a metal source coating tape containing aluminum and other additives in advance, thereafter disposing the same partially to a selective region to be applied with the coating and finally heating the selective region under an inert atmosphere by utilizing a quartz infrared lamp to partially form a diffusion aluminide coating.

### SUMMARY OF THE INVENTION

In a powder pack cementation method or a chemical vapor deposition method generally used as a method of forming a diffusion aluminide coating, it was difficult to apply a diffusion aluminide coating partially to the selective region.

Further, the slurry method as the prior art requires blending, coating, and drying of the slurry, which complicate the steps. Further, a portion of the ingredients of a liquid carrier forming the slurry results in decomposition by-products upon a diffusion heat treatment to form residual impurities, thereby possibly leaving an undesirable contamination.

Further, the method of using partial heating by a metal source coating tape and a quartz infrared lamp requires preparing a tape holder or a cushioning material in advance which is, at a high temperature, stable enough to keep adhesion between the metal source coating tape and a substrate, and unfailingly arranging and fixing the same to an arbitrary region of a complicated blade shape.

The present invention intends to provide a method of applying a diffusion aluminide coating partially to a selective region more simply and conveniently.

A method of applying a diffusion aluminide coating according to the invention is a method of applying a diffusion aluminide coating to a selective region on the surface of a heat-resistant alloy substrate including

(a) a step of forming a metal aluminum film onto a selective region of a heat-resistant alloy substrate to be applied with the coating; and

(b) a step of applying a heat treatment to the heat-resistant alloy substrate on the selective region of which the metal aluminum film is formed and diffusing and penetrating aluminum in the metal aluminum film into the heat-resistant alloy substrate.

As a method of forming the metal aluminum film onto a selective region, a cold spray method is used preferably.

Further, the thickness of the metal aluminum film is preferably from 10 to 200 μm, and as a condition for the heat treatment, it is preferred to apply the heating treatment at a temperature from 900 deg. C. to 1200 deg. C. in vacuum for 1 to 10 hours.

The heat treatment condition is determined depending on the condition capable of applying a sufficient diffusive penetration of aluminum into the substrate, as well as on the requirement on the side of the substrate.

More preferred applications of the invention for the heat-resistant alloy substrate include, for example, hot section parts of a gas turbine such as blades, nozzles and combustors, and it is particularly preferred to apply the diffusion aluminide coating of the invention to a selective region at the blade tip of a gas turbine.

As heat-resistant alloy substrates, Ni-base or Co-base substrates are desirable.

Metal aluminum to form the coating film is pure (95 to 99% purity) aluminum, and the purity of aluminum upon using the cold spray method is about 99% and the purity after the coating and before a heat treatment is about 95%.

The invention can provide a method of applying a diffusion aluminide coating partially to a selective region more simply and conveniently.

### DESCRIPTION OF THE ACCOMPANYING DRAWINGS

FIG. 1 is a perspective view for a blade of a gas turbine; and

FIG. 2 is a schematic cross-sectional view showing a diffusion aluminide coating layer in a selective region at the tip of a blade by a method shown in the embodiment.

11 . . . airfoil
12 . . . platform
13 . . . shank
14 . . . seal fins
15 . . . tip pocket
16 . . . dovetail
21 . . . bond coat
22 . . . aluminum film

### DESCRIPTION OF PREFERRED EMBODIMENTS

The present invention is to be described by way of a preferred embodiment.

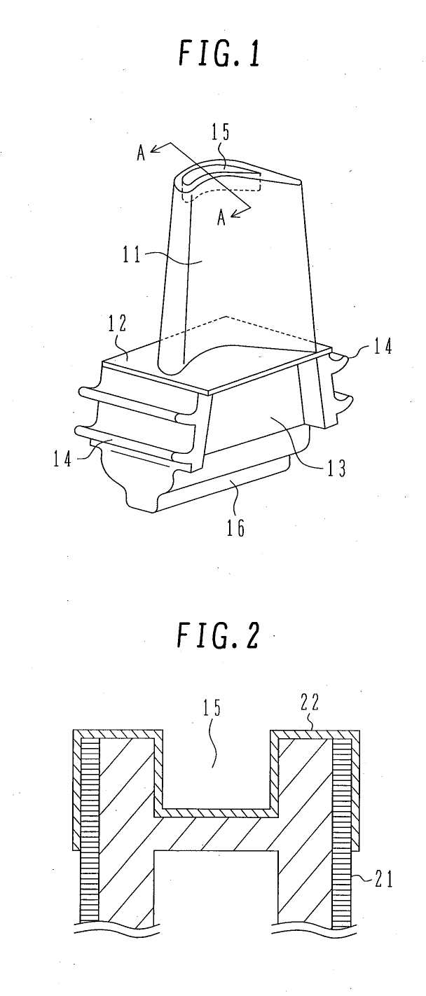

FIG. 1 is a perspective view of a blade of a gas turbine according to this embodiment (hereinafter referred to as “blade”).

The blade shown in this embodiment is a substrate formed of an Ni-base heat resistant alloy (Rene′-80:Ni-14% Cr-4% Mo-4% W-3% Al-5% Ti-9.5% Co: wt %).

The blade shown in this embodiment is used, for example, as a blade of a first stage of a gas turbine having three stages of blades.

The blade includes an airfoil 11; a platform 12; a shank 13; seal fins 14; a tip pocket 15; and a dovetail 16, and is attached by way of the dovetail 16 to a disk (not illustrated).

Further, the blade has, for example, a length of 100 mm for the airfoil 11 and a length of 120 mm from the platform 12 to the dovetail 16.

The blade is provided with a cooling passage (not illustrated) passing from the dovetail 16 to the airfoil 11 in order to allow a cooling medium, particularly, air or steam to pass through it such that the blade can be cooled from the inside.

FIG. 2 shows a schematic cross-sectional view along arrow A-A in FIG. 1.

In the blade, a bond coat 21 was formed by a plasma spray method under a low pressure using a powder of a CoNiCrAlY alloy (Co-32% Ni-21% Cr-8% Al-0.5% Y: wt %) to the airfoil 11 and the platform 12 exposed to a combustion gas.

Then, an aluminum film 22 at 100 μm thickness was formed by a cold spray method to a selective region near the tip pocket 15 formed at the blade tip.

Upon cold spray, a pure aluminum powder with a grain diameter of the powder particle being 5 to 20 μm was used. As a spray condition, air was used as a working gas, and the cold spray was conducted under a pressure of 0.6 MPa and at a working gas temperature of about 300 deg. C. The spray distance was set to 10 mm, the traverse speed was set to 20 mm/sec, and the traverse pitch was set to 2 mm.

After forming the aluminum film 22, a heat treatment is applied to the blade in vacuum at a temperature of 1121 deg. C. for 4 hours, and aluminum was penetrated by diffusion into the substrate to form a diffusion aluminide coating in the selective region near the tip pocket 15 formed at the blade tip.

The heat treatment also serves as a diffusion treatment between the bond coat 21 formed by the plasma spray method under a low pressure and the substrate, and as a solution heat treatment for the substrate.

Further, as an aging heat treatment for the substrate, the blade was applied with a heat treatment at a temperature of 843 deg. C. in vacuum for 24 hours. Yttria partially-stabilized Zirconia with 8 wt % at about 300 μm thickness was applied by an atmospheric plasma spray method to the surface of the airfoil 11 and the platform 12 of the blade after the heat treatment.

When the blade with the tip pocket 15 formed at the blade tip in the vicinity of which the diffusion aluminide coating was applied by using the method of applying the diffusion aluminide coating was assembled into the gas turbine and operated, oxidation damage was scarcely observed at the blade tip and on the periphery of the tip pocket 15 of the blade, showing good oxidation resistance.

On the other hand, in the blade not applied with the diffusion aluminide coating, oxidation damage occurred at the blade tip, and it was also observed on the periphery of tip pocket 15.

While the description has been made to an example of this embodiment, various modifications, etc. are possible by those skilled in the art. Accordingly, the invention is not necessarily restricted to this embodiment.

According to the method of applying a diffusion aluminide coating to a selective region on the surface of a substrate formed of a heat-resistant alloy as in this embodiment, the diffusion aluminide coating can be applied by a simple step of forming a metal aluminum film onto a selective region to be applied with the desired diffusion aluminide coating and applying a heat treatment to that selective region.

For a method of forming a metal aluminum film to the selective region used in this embodiment, use of the cold spray method is preferred.

In the cold spray method, the working gas temperature is within a range from 300 deg. C. to 600 deg. C., and since it is lower than that used in other film-formation methods such as a spray method (the working gas temperature is about 2000 deg. C. or higher depending on a heat source), the spray distance can be made closer to a range of 5 to 10 mm. Accordingly, spay patterns are restricted to a shape substantially identical with that of a nozzle and do not spread. Therefore, this provides a merit that masking is not necessary for the portion other than the selective region.

Further, in the cold spray method, since the working gas temperature is low, oxidation of the powder particles scarcely occurs, so that this also provides a merit that oxide inclusions are also not contained substantially in the film and the oxide inclusions do not hinder the diffusion of aluminum into the substrate during the step of a heat treatment after film-formation.

The thickness of the metal aluminum film is preferably within a range from 10 to 200 μpm.

With a film less than 10 μm thick, the amount of aluminum diffusing and penetrating into the substrate is insufficient, and a diffusion aluminide coating layer having a sufficient aluminum concentration is not formed after the heat treatment, which is not preferred.

On the other hand, with the film more than 100 μm thick, the amount of aluminum diffusing and penetrating into the substrate is excessive, and the diffusion aluminide coating layer formed becomes fragile, which is also not preferred.

Further, in order that the metal aluminum film may diffuse and penetrate into the substrate, it is necessary that the heat treatment after the metal aluminum film-formation has to be kept at a necessary temperature for a sufficient time, and it should preferably be kept within a temperature range from 900 deg. C. to 1200 deg. C. for a period from 1 to 10 hours.

Further, in accordance with a desired thickness of diffusion aluminum coating and a desired rate of content of aluminum in the diffusion aluminum coating, a combination of the film thickness of the metal aluminum films, the heat treatment temperature and the retention time is properly selected.

As a preferred selection for simplifying the steps, the thickness of the metal aluminum film formed before the heat treatment can be selected so that a desired film thickness of the diffusion aluminide coating layer and a desired rate of content of aluminum therein are obtained in accordance with the conditions for a solution heat treatment or an aging heat treatment for the substrate.

Further, as an atmosphere for the heat treatment, the heat treatment should preferably be applied in vacuum since oxidation of aluminum is prevented in vacuum, and generated aluminum vapors are also exhausted without attaching themselves to the portion other than the selective region.

As a stage of the gas turbine to which the blade is provided, a first stage is most excellent. However, the blade can also be disposed in a second stage or subsequent stages.

Further, this embodiment can provide a method of applying a diffusion aluminide coating layer to the selective region of the heat-resistant alloy substrate of a gas turbine and improve the corrosion resistance and oxidation resistance of the substrate in the selective region. As a result, this can extend the machine life and improve the performance of equipment due to improvement of its durability.

In addition to the gas turbine, this invention can also be utilized for heat-resistant parts of steam turbines, boilers, and automobile engines.

Since this embodiment can be applied by a simple step, it is also excellent in workability and reliability and is advantageous from an economical view point as well.

The diffusion aluminide coating is also referred to as aluminization or Al pack. While it includes several modes, it basically is a method of diffusing and penetrating aluminum to the surface of a Ni-base or Co-base heat-resistant alloy substrate, or to the surface of an alloy layer of MCrAlX (M represents Ni, Co, Fe, or a combination thereof, and X represents element other than M, Cr, Al) disposed as a corrosion-resistant and oxidation-resistant coating to the surface of a Ni-base or Co-base heat-resistant alloy substrate, so as to form an aluminum enriched layer (a layer of an aluminum concentration of 20 to 40%) on the surface of the substrate.

By inter-diffusion between metals of the substrate and aluminum, aluminum diffuses and penetrate from the aluminum film of an aluminum concentration of 90% or higher to the substrate to form an aluminum-enriched layer of an aluminum concentration of 20 to 40% .

By this enriched aluminum, a protective alumina (aluminum oxide) film is stably formed and maintained on the surface of the substrate under a high temperature operating circumstance, leading to suppressing oxidation damage to the substrate.

Further, for stably forming and maintaining the protective alumina film, an effective element, for example, noble metals may be added to aluminum and diffused and penetrated. As a typical example, with an addition of platinum (Pt), a diffusion coating of platinum and aluminum is preferred. This diffusion aluminide coating is excellent in oxidation resistance and corrosion resistance at a high temperature.

Further, for the diffusion aluminide coating in this embodiment (enriched layer), enrichied layers having the aluminum content rate of from 20 to 40% by weight are used. These enriched layers are better particularly in oxidation resistance at a high temperature than an overlay coating of an MCrAlX alloy with the aluminum content rate as low as 6 to 15% by weight.

In recent gas turbines in which the combustion temperature has been increased to improve efficiency, the diffusion aluminide coating tends not to be applied over the entire surface of the blade where thermal stress is high and particularly fatigue cracking is scarcely allowed since it is a rotational body, and it is desired to apply the diffusion aluminide coating to the selective region shown in the embodiment.

The present invention can be utilized for blades of gas turbines used in power generation plants.

What is claimed is:

1. A method of applying a diffusion aluminide coating to a selective region on the surface of a heat-resistant alloy substrate to form an aluminum diffusion penetration layer including:
(a) a step of forming a metal aluminum film onto a selective region of the heat-resistant alloy substrate to be treated; and
(b) a step of applying a heat treatment to the heat-resistant alloy substrate on the selective region of which the metal aluminum film is formed and diffusing and penetrating aluminum in the metal aluminum film into the heat-resistant alloy substrate.

2. A method of applying a diffusion aluminide coating according to claim 1, wherein a cold spray method is employed as a method of forming the metal aluminum film in the selective region.

3. A method of applying a diffusion aluminide coating according to claim 1, wherein the thickness of the metal aluminum film is from 10 to 200 μm.

4. A method of applying a diffusion aluminide coating according to claim 1, wherein the heat treatment is applied at a temperature from 900 deg. C. to 1200 deg. C. in vacuum for 1 to 10 hours.

5. A method of applying a diffusion aluminide coating according to claim 1, wherein the heat-resistant alloy substrate is a hot section part of a gas turbine.

6. A method of applying a diffusion aluminide coating according to claim 1, the selective region is at the blade tip of the gas turbine.
